(19) United States
(12) Patent Application Publication
(10) Pub. No.: US 2025/0200773 A1
(43) Pub. Date: Jun. 19, 2025

(54) DEPTH ESTIMATION USING ACTIVE SENSING AND STRUCTURED LIGHT

(71) Applicant: QUALCOMM Incorporated, San Diego, CA (US)

(72) Inventors: Volodimir Slobodyanyuk, San Diego, CA (US); Amin Ansari, Kirkland, WA (US); Ahmed Kamel Sadek, San Diego, CA (US)

(21) Appl. No.: 18/540,294

(22) Filed: Dec. 14, 2023

(51) Int. Cl. G06T 7/521; G01B 11/22; G06V 10/774; G06V 20/58

(52) U.S. Cl. CPC G06T 7/521; G01B 11/22; G06V 10/774; G06V 20/58; G06T 2207/10012; G06T 2207/10028; G06T 2207/10048; G06T 2207/20081; G06T 2207/30261

(57) ABSTRACT

A depth map for a scene may be generated by projecting, by a light projector, an illumination pattern onto a scene; capturing, by a camera, a camera image of the scene; generating, by a computing device, a plurality of ground truth depth values for sample pixels of the camera image based at least in part on the illumination pattern; and estimating a depth map for the scene based at least in part on the camera image and the ground truth depth values for sample pixels.

### TECHNICAL FIELD

This disclosure relates to computer vision.

### BACKGROUND

Autonomous vehicles and semi-autonomous vehicles may include an advanced driver assistance system (ADAS) using sensors and software to help operate the vehicles. An ADAS may use artificial intelligence (AI) and machine learning (ML) (e.g., deep neural network (DNN)) techniques for performing various operations for operating, piloting, and navigating the vehicles. For example, ML models may be used for object detection, lane and road boundary detection, safety analysis, drivable free-space analysis, control generation during vehicle maneuvers, and/or other operations. ML model-powered autonomous and semi-autonomous vehicles should be able to respond properly to an incredibly diverse set of situations, including interactions with emergency vehicles, pedestrians, animals, and a virtually infinite number of other obstacles.

ML has revolutionized many aspects of computer vision. For example, the computer vision task of depth estimation based on captured image data is useful for autonomous and semi-autonomous systems (such as autonomous and semi-autonomous vehicles), to perceive and navigate the surrounding environment. Yet, estimating the depth of an object in image data by a ML model remains a challenging computer vision task.

### SUMMARY

This disclosure describes techniques and devices for performing depth estimation using ground truth depth values determined from structured light. A light projector may be used to project light in an illumination pattern onto a scene. The projected light reflects off at least one object in the scene (e.g., a parked or moving vehicle, a road sign, road barrier, etc.). A camera creates a camera image of the scene at a point in time. A structured light analyzer may analyze the camera image and the illumination pattern and generate an estimated 3D representation of scene at that point in time from deformations and/or distortions of the reflected illumination pattern on any objects in the scene. The structured light analyzer may output the depth portion of the 3D representation as ground truth depth values for sample pixels of the camera image. A ML depth model, during inference operation, may use the camera image, camera parameters, and the ground truth depth values for sample pixels to determine a depth map. The depth map may then be used for further computer vision processing, such as object detection. The techniques described herein to generating ground truth depth values based on structured light may be considerably less expensive compared to previous Light Detection and Ranging (LIDAR)-based approaches. Aspects may also be used to improve the accuracy of depth estimation for monocular images or stereo images.

In an aspect, a method includes projecting, by a light projector, an illumination pattern onto a scene; capturing, by a camera, a camera image of the scene; generating, by a computing device, a plurality of ground truth depth values for sample pixels of the camera image based at least in part on the illumination pattern; and estimating a depth map for the scene based at least in part on the camera image and the ground truth depth values for sample pixels.

In another aspect, an apparatus includes a memory that stores instructions; and processing circuitry that executes the instructions to generate a plurality of ground truth depth values for sample pixels of a scene captured in a camera image by a camera, one or more objects of the scene reflecting light projected onto the scene by a light projector in an illumination pattern; and estimate a depth map for the scene based at least in part on the camera image and the ground truth depth values for sample pixels.

In a further aspect, non-transitory computer-readable storage media comprising instructions, that when executed by processing circuitry of a computing system, cause the processing circuitry to generate a plurality of ground truth depth values for sample pixels of a scene captured in a camera image by a camera, one or more objects of the scene reflecting light projected onto the scene by a light projector in an illumination pattern; and estimate a depth map for the scene based at least in part on the camera image and the ground truth depth values for sample pixels.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example autonomous vehicle in accordance with the techniques of this disclosure.

FIG. 2 is a block diagram illustrating an example computing system that may perform the techniques of this disclosure.

FIG. 3 is a block diagram illustrating depth estimation using active sensing and structured light, in accordance with the techniques of this disclosure.

FIG. 4 is a conceptual diagram illustrating an example training architecture for partial supervision of self-supervised monocular depth estimation, in accordance with the techniques of this disclosure.

FIG. 5 is a flow diagram illustrating an example method for depth estimation using active sensing and structured light in accordance with the techniques of this disclosure.

### DETAILED DESCRIPTION

Aspects of the present disclosure provide apparatuses, methods, computing systems and non-transitory computer-readable media for performing partial supervision of self-supervised monocular depth estimation using estimated ground truth depth values generated by active sensing and structured light techniques.

Estimating depth information in image data is a common task in computer vision applications, which can be used in simultaneous localization and mapping (SLAM), navigation, object detection, and semantic segmentation, to name just a few examples. For example, depth estimation is useful for determining obstacle avoidance for vehicles driving autonomously or semi-autonomously or with assistance, drones flying autonomously or semi-autonomously, warehouse or household robots operating autonomously or semi-autonomously, spatial scene understanding, and other examples.

Traditionally, depth has been estimated using binocular (or stereo) image sensor arrangements and has been based on calculating the disparity between corresponding pixels in different binocular images. However, in cases in which there is only one perspective, such as when using a single image sensor, traditional stereoscopic methods cannot be used. Single image sensor depth estimation is referred to as monocular depth estimation. Monocular depth estimation has proven challenging in scenarios where objects in a scene are moving, often in uncorrelated and different directions, at different speeds, etc. Nevertheless, deep learning methods have been developed for performing depth estimation in the monocular context.

Monocular image sensors tend to be ubiquitous, low cost, small, and low power, which makes such sensors desirable in a wide variety of applications such as vehicles, robots, drones, etc. However, even the most advanced camera-based depth estimation solutions may be underperforming due to the inherent variability of the camera image sensor operation. For example, the tendency of the camera to change the image sensor's pixel exposure time in different lightning conditions often results in non-uniform operation of the camera, thus making the depth estimation task also dependent on this variability.

One way to handle this problem is to provide a feedback mechanism to depth estimation processing, where the actual depth values, called ground truth (GT) depth values herein, are also provided to a depth estimation ML model (along with camera images), so that depth estimation processing may compensate in real time for the errors in depth estimation caused by camera image sensor operations. These GT depth values may be dense or sparse (e.g., when another ranging sensor used).

In scenarios where the GT depth values are dense, depth estimation processing may not be needed. In some scenarios, LIDAR sensors may be used to generate GT depth values for a depth estimation system, however the GT depth values are typically sparse. However, this solution may be too expensive for many applications (such as vehicles, drones, robots, etc.), since LIDAR systems are large and may be prohibitively expensive for many applications.

Aspects of the disclosure use active sensing and structured light techniques to generate GT depth values for depth estimation processing in an efficient and cost-effective manner. In an aspect, generating GT depth values based on structured light as described herein may be considerably less expensive compared to previous LIDAR-based approaches. Additionally, the GT depth values determined using structured light techniques may be input to model training using self-supervision in addition to, or in place of, LIDAR-based GT depth values. Aspects may also be used to improve the accuracy of depth estimation for monocular images or stereo images.

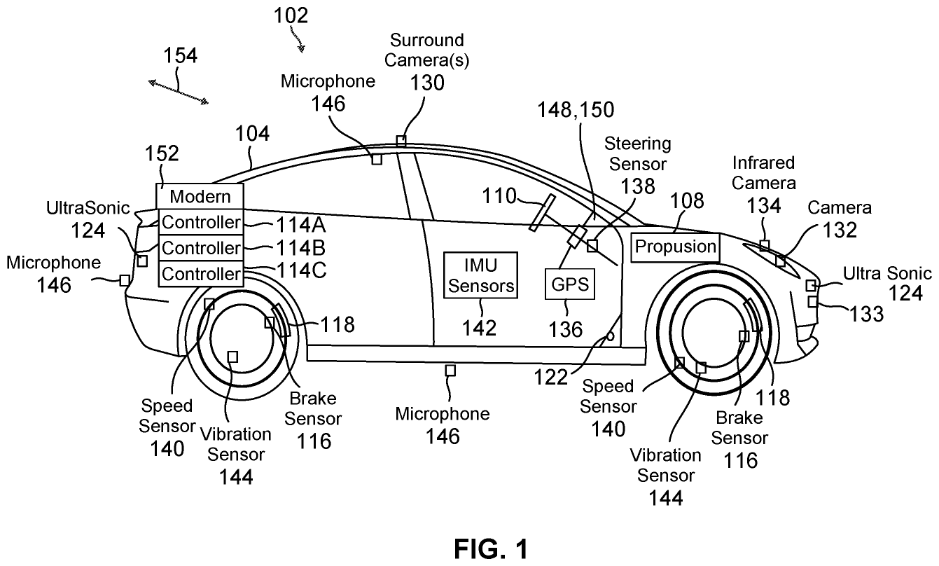

FIG. 1 is a diagram of an example autonomous vehicle, in accordance with the techniques of this disclosure. Autonomous vehicle 102 in the example shown may comprise any vehicle (such as a car, van or truck) that can accommodate a human driver and/or human passengers. Autonomous vehicle 102 may include a vehicle body 104 suspended on a chassis, in this example comprised of four wheels and associated axles.

In an aspect, light projector 133 projects light in an illumination pattern in front of autonomous vehicle 102. In other aspects, light may be projected in other directions around the autonomous vehicle. In an aspect, the light may be near infrared light. Light reflected off objects in the path of the projected light (for example, in the scene on front of the vehicle) may be captured by camera 132. The light reflected off objects in the path may be analyzed to generate GT depth values using various image processing techniques.

A propulsion system 108, such as an internal combustion engine, hybrid electric power plant, or even all-electric engine, may be connected to drive some or all the wheels via a drive train, which may include a transmission (not shown). A steering wheel 110 may be used to steer some or all the wheels to direct autonomous vehicle 102 along a desired path when the propulsion system 108 is operating and engaged to propel the autonomous vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be one or more onboard computer systems that may be configured to perform deep learning and AI functionality and output autonomous operation commands to autonomous vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide AI functionality for in-camera sensors, and controller 114D (not shown in FIG. 1) may provide infotainment functionality and provide additional redundancy for emergency situations.

Controller 114 may send command signals to operate vehicle brakes (using brake sensor 116) via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”), a network inside modern vehicles used to control brakes, acceleration, steering, windshield wipers, and the like. The CAN bus may be configured to have dozens of nodes, each with its own unique identifier (CAN ID). The bus may be read to find steering wheel angle, ground speed, engine revolutions per minute (RPM), button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be provided with dedicated hardware and software, allowing control of throttle, brake, steering, and shifting. The hardware may provide a bridge between the vehicle's CAN bus and the controller 114, forwarding vehicle data to controller 114 including the turn signals, wheel speed, acceleration, pitch, roll, yaw, Global Positioning System (GPS) data, tire pressure, fuel level, sonar, brake torque, and others. Similar actuation controllers may be configured for any make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more surround cameras 130 (typically such cameras are located at various places on vehicle body 104 to image areas all around the vehicle body), one or more cameras 132 (in an aspect, at least one such camera may face forward to provide object recognition in the vehicle's path), one or more infrared cameras 134, GPS unit 136 that provides location coordinates, a steering sensor 138 that detects the steering angle, speed sensors 140 (one for each of the wheels), an inertial sensor or inertial measurement unit (IMU) 142 that monitors movement of vehicle body 104 (this sensor may be, for example, an accelerometer(s) and/or a gyro-sensor(s) and/or a magnetic compass(es)), tire vibration sensors 144, and microphones 146 placed around and inside the vehicle. Other sensors may also be used.

Controller 114 may also receive inputs from an instrument cluster 148 and may provide human-perceptible outputs to a human operator via human-machine interface (HMI) display(s) 150, an audible annunciator, a loudspeaker and/or other means. In addition to traditional information such as velocity, time, and other well-known information, HMI display may provide the vehicle occupants with information regarding maps and vehicle's location, the location of other vehicles (including an occupancy grid) and even the controller's identification of objects and status. For example, HMI display 150 may alert the passenger when the controller has identified the presence of a water puddle, stop sign, caution sign, or changing traffic light and is taking appropriate action, giving the vehicle occupants peace of mind that the controller is functioning as intended. In an aspect, instrument cluster 148 may include a separate controller/processor configured to perform deep learning and AI functionality.

Autonomous vehicle 102 may collect data that is preferably used to help train and refine the neural networks used for autonomous driving. The autonomous vehicle 102 may include modem 152, preferably a system-on-a-chip (SoC) that provides modulation and demodulation functionality and allows the controller 114 to communicate over the wireless network 154. Modem 152 may include a radio frequency (RF) front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: long term evolution (LTE), wideband code division multiple access (WCDMA), universal mobile telecommunications framework (UMTS), global system for mobile communications (GSM), CDMA2000, or other known and widely used wireless protocols.

It should be noted that, compared to other sensors, cameras 130-134 may generate a richer set of features at a fraction of the cost. Thus, autonomous vehicle 102 may include a plurality of cameras 130-134, capturing images around the entire periphery of the autonomous vehicle 102. Camera type and lens selection depends on the nature and type of function. Autonomous vehicle 102 may have a mix of camera types and lenses to provide complete coverage around the autonomous vehicle 102; in general, narrow lenses do not have a wide field of view but can see farther. All cameras on autonomous vehicle 102 may support interfaces such as Gigabit Multimedia Serial link (GMSL) and Gigabit Ethernet.

In some examples, camera 132 may be responsible for capturing high-resolution images and processing them in real time. The output images of such camera-based systems may be used in applications such as depth estimation, object detection, and/or pose detection, including the detection and recognition of objects, such as other vehicles, pedestrians, traffic signs, and lane markings. Camera 132 may be particularly good at capturing color and texture information, which is useful for accurate object recognition and classification.

Camera 132 may generally be any type of camera configured to capture video or image data in the environment around autonomous vehicle 102. For example, camera 132 may include a front facing camera (e.g., a front bumper camera, a front windshield camera, and/or a dashcam), a back facing camera (e.g., a backup camera), side facing cameras (e.g., cameras mounted in sideview mirrors), or surround cameras. Camera 132 may include color cameras or grayscale cameras. In some examples, camera 132 may include a camera system having more than one camera sensor.

In an aspect, a controller 114 may receive one or more images acquired by a plurality of camera 132. Controller 114 may include a portion of an ADAS to perform structured light analysis and depth estimation in accordance with the techniques of this disclosure. For example, controller 114 may be configured to receive a camera image generated by camera 132 that captures light reflected off an object in a subset of a scene (e.g., a sparse ground truth) in response to an illumination pattern being projected onto the object, analyze the structured light represented in the camera image and determine GT depth values for sample pixels of the camera image. Controller 114 may then perform improved depth estimation processing using camera parameters, the camera image, and the GT depth values for sample pixels of the camera image.

Although the techniques of this disclosure are described with respect to implementation in autonomous vehicle 102 (including ADAS), in other implementations the techniques may be used in drones, robots, ships, airplanes, helicopters, motorcycles, or other applications involving moving objects.

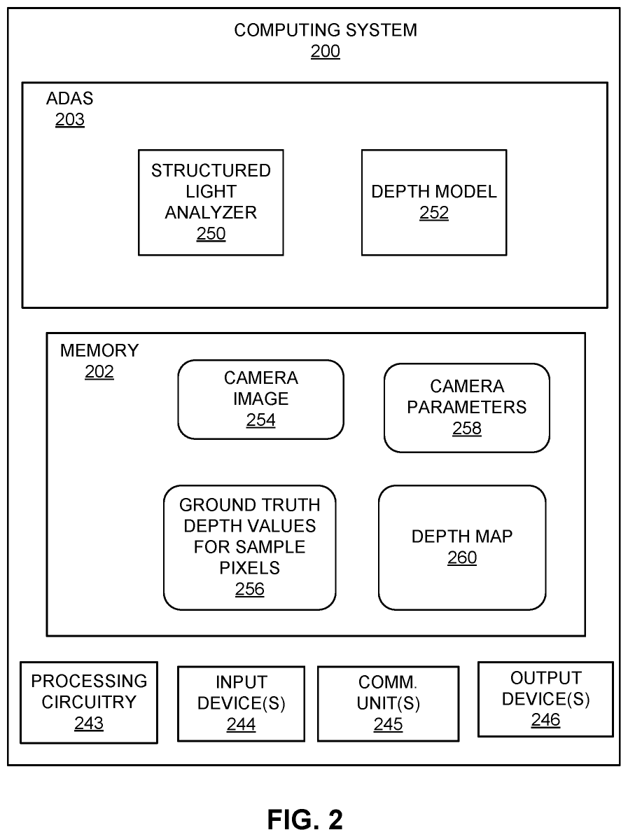

FIG. 2 is a block diagram illustrating an example computing system that may perform the techniques of this disclosure. As shown, computing system 200 comprises processing circuitry 243 and memory 202 for executing ADAS 203, which may represent an example instance of any controller 114 described in this disclosure, such as controllers 114A, 114B, and 114C of FIG. 1.

Ground truth depth values for sample pixels 256 may be generated by various techniques. This disclosure provides for the use of active sensing and structured light techniques to generate ground truth depth values for sample pixels 256 in a cost effective and efficient way.

In an aspect, ADAS 203 may include structured light analyzer 250 and depth model 252. Structured light analyzer 250 determines ground truth (GT) depth values for sample pixels 256, based at least in part on camera image 254 received from camera 132, the camera image including data representing light reflected off one or more objects in a scene captured in the camera image, the reflected light including reflections of an illumination pattern from light projector 133. Depth model 252 estimates depth values for objects in the scene captured in camera image 254 using camera parameters 258, camera image 254, and GT depth values for sample pixels 256. The depth values may be output as depth map 260, which may be used in other ADAS processing (e.g., object detection, etc.). In an aspect, camera parameters 258 may include a number of pixels of an image sensor of camera 132, focal length, field of view, pixel dimensions, resolution, etc.

Depth model 252 may include a machine learning (ML) depth model, and/or include various types of neural networks, such as, but not limited to, recursive neural networks (RNNs), convolutional neural networks (CNNs), and deep neural networks (DNNs).

Computing system 200 may be implemented as any suitable external computing system accessible by controller 114, such as one or more server computers, workstations, laptops, mainframes, appliances, embedded computing systems, cloud computing systems, High-Performance Computing (HPC) systems (i.e., supercomputing systems) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. In an aspect, computing system 200 is disposed in vehicle 102.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure. Processing circuitry 243 may include one or more central processing units (CPUs), such as single-core or multi-core CPUs, graphics processing units (GPUs), digital signal processor (DSPs), neural processing unit (NPUs), multimedia processing units, and/or the like.

An NPU is a specialized circuit configured for implementing control and arithmetic logic for executing machine learning algorithms, such as algorithms for processing artificial neural networks (ANNs), DNNs, random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

In another example, computing system 200 comprises any suitable computing system having one or more computing devices, such as desktop computers, laptop computers, gaming consoles, smart televisions, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random-access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable read only memories (EPROM) or electrically erasable and programmable (EEPROM) read only memories.

Memory 202 may store program instructions and/or data associated with one or more of the modules described in accordance with one or more aspects of this disclosure. For example, memory 202 may store camera image 254 received from camera 132, camera parameters 258 of camera 132, GT depth values for sample pixels 256, and depth map 260, as well as instructions of ADAS 203, including one or more of structured light analyzer 250 and depth model 252.

Processing circuitry 243 and memory 202 may provide an operating environment or platform for one or more modules or units (e.g., ADAS 203, including one or more of structured light analyzer 250 and depth model 252, etc.), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute ADAS 203, including one or more of structured light analyzer 250 and depth model 252, using virtualization modules, such as a virtual machine or container executing on underlying hardware. One or more of such modules may execute as one or more services of an operating system or computing platform. Aspects of ADAS 203, including one or more of structured light analyzer 250 and depth model 252, may execute as one or more executable programs at an application layer of a computing platform.

One or more input device(s) 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output device(s) 246 may generate, transmit, or process output. Examples of output are tactile, audio, visual, and/or video output. Output devices 246 may include a display, sound card, video graphics adapter card, speaker, presence-sensitive screen, one or more universal serial bus (USB) interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, 5G and Wi-Fi® radios found in mobile devices as well as Universal Serial Bus (USB) controllers and the like.

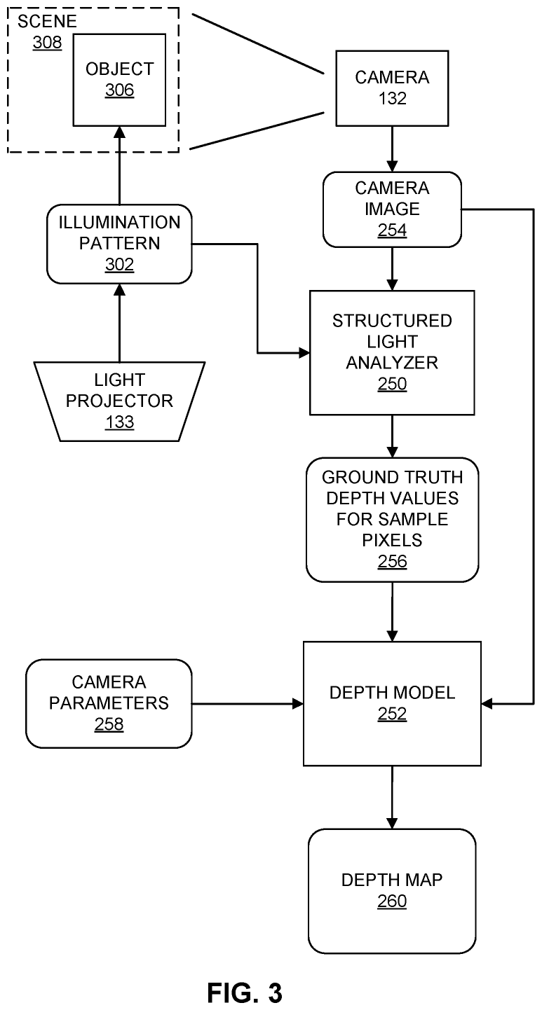

FIG. 3 is a block diagram illustrating depth estimation using active sensing and structured light, in accordance with the techniques of this disclosure. Light projector 133 projects light in illumination pattern 302 (e.g., a coded pattern, which may include code words) onto scene 308. In an example, light projector may include a laser diode. In an example, the light may be projected in front of autonomous vehicle 102 as the vehicle is in transit. The projected light reflects off at least one object 306 in scene 308 (e.g., a parked or moving vehicle, a road sign, road barrier, etc.). In an aspect, light projector 133 projects near infra-red (NIR) light. Camera 132, using an image sensor (not shown in FIG. 3) creates camera image 254 of scene 308 (including object 306) at a point in time. Structured light analyzer 250 analyzes camera image 254 and illumination pattern 302 and generates an estimated 3D representation of scene 308 from assessing deformations and/or distortions of the reflected illumination pattern on any objects in scene 308, the objects having x, y, and z (depth) parameters, where zᵢⱼ is an estimated depth value at pixel (i, j). Structured light analyzer 250 outputs the z (depth) portion of the 3D representation as ground truth depth values for sample pixels 256. Depth model 252, during inference operation, uses camera image 254, camera parameters 258 and ground truth depth values for sample pixels 256 to determine depth map 260. Depth map 260 may then be used for ADAS 203 processing such as object detection or other computer vision processing.

There are many structured light-based techniques to perform 3D reconstruction and infer depth from a given scene. These techniques typically work based on encoding a pattern. Then, this pattern or multiple patterns get projected into the scene and one or multiple images will get captured. The 3D scene geometry may be understood from comparing the captured images with the projected pattern. Example encoding patterns may include structured binary codes, N-ary coding, triangular phase coding, trapezoidal phase coding, continuous sinusoidal phase coding, binary gray coding, gray level patterns, rainbow pattern, continuously varying color coding, stripe indexing using color, strip indexing using segment patterns, De Brujin sequence-based patterns, pseudo random binary array patterns, 2D array of color coded dots, etc. A technique such as strip indexing using colors may be implemented in the present system in conjunction with real-time 3D surface imaging without requiring projecting of multiple patterns. 3D reconstruction relies on the triangulation principle between an imaging sensor, a structured-light projector and an object surface. Once the association of points between the projected pattern and captured image is known, calculating depth is the matter of performing triangulation operations.

In an aspect, structured light analyzer 250 may perform 3D object reconstruction from structured light according to one of the techniques described in “Structured-Light 3D Source Imaging: A Tutorial” by Jason Geng, Institute of Electrical and Electronics Engineers (IEEE) Intelligent Transportation Society, Doc. ID 134160, Mar. 31, 2011.

In another aspect, structured light analyzer 250 may perform 3D object reconstruction from structured light according to one of the techniques described in “Structured Light II”, by Guido Gerig, Carnegie Mellon University Computer Science (CS) 6320, 2013. In other implementations, other structured light analyzer processing techniques may be used.

By using ground truth depth values for sample pixels 256 generated by structured light analyzer 250, depth model 252, during inference operation, may compare the ground truth depth values for sample pixels 256 and depth map 260 to refine the depth map and resolve the scale of any objects (such as object 306) in scene 308.

In some examples, the structured light analysis techniques of this disclosure are range-based and may operate very effectively at ranges of approximately a few meters in the outdoor environment. The farther illumination pattern 302 is projected by light projector 133, the higher the transmission power needed. In a daylight environment, this may work to project the illumination pattern approximately a few meters (e.g., two or three meters) away from autonomous vehicle 102. For the purpose of generating sparse ground truth depth values, this may be sufficient to estimate an error in depth estimation processing, thus providing an indication to depth model 252 of the amount of error compensation that may be required.

The use of structured light analysis also supports scale ambiguity rectification by depth model 252 (which works under the principles of self-supervision). Existing monocular depth estimation systems typically employ self-supervision techniques to derive depth from a scene in the absence of ground truth for depth. A problem with these approaches is the inherent scale ambiguity. For example, if the scene is scaled down by 10X, objects will still look the same to camera 132. The techniques of the disclosure can help to disambiguate the scale due to having GT depth values for a small set of camera pixels.

Self-supervision depth estimation results in depth ambiguity as the world will look the same in the perspective view of a camera no matter the scale. As a result, depth estimation methods seek to resolve the scale. To this end, a median matching process may be used which tries to match the median of the predicted depth map with the median depth from the ground truth to perform accuracy measurement. Since one can infer depth for a small set of pixels using the structured light, the need for the median matching during evaluation may be eliminated and those pixels may be used to disambiguate the scale. In addition, scaled depth values may be generated during inference (which is useful for many applications including automotive and virtual reality/augmented reality (VR/AR)). The predicted depth values may be compared with the depth values of the small set of pixels and a scaling ratio may be derived based on the average depth for the set of pixels across both sets of depth values.

At inference time, the structured light may be used to provide depth GT for a subset of pixels (the number of these pixels changes depending on the exact position of the object that the structured light is shined on (in other words, if the object is closer, the number of pixels will increase and vice versa)). Therefore, these pixels may be used to determine what scaling factor should be used to scale depth map 260. Scaling may be done using the median (or mean, or some other statistical metric) depth of the values inside the GT from the structured light.

Although the above description refers to monocular depth estimation, the use of active sensing and structured light may also be applied to stereo depth estimation techniques.

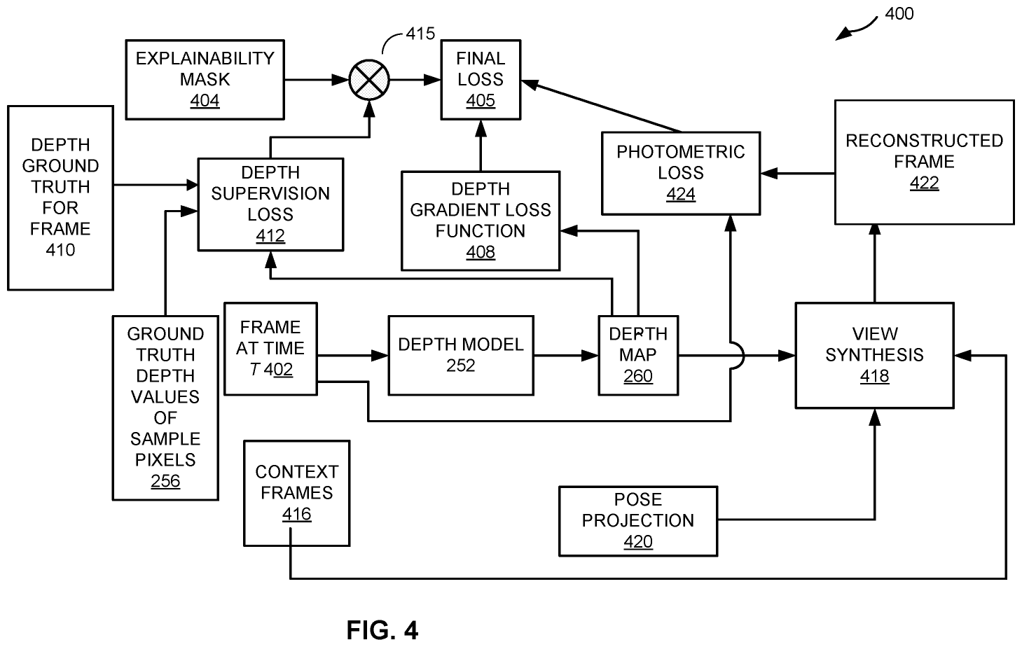

FIG. 4 is a conceptual diagram illustrating an example training architecture 400 for partial supervision of self-supervised monocular depth estimation. Initially, a frame 402 of camera image 254 data at time t may be provided to machine learning (ML) depth model 252, such as a neural network model. As described above, depth model 252 processes camera image 254 data and generates depth map 260. In an aspect, depth model 252 also uses camera parameters 258 when generating depth map 260. Depth map 260 may take different forms, such as a depth map indicating the estimated depth value of each pixel directly (e.g., a two-dimensional (2D) array of depth values for each pixel of frame at time t 402), or a disparity map indicating the disparity between pixels. Depth and disparity are related and can be proportionally derived from each other.

Depth map 260 may be provided to depth gradient loss function 408, which determines a loss based on, for example, the “smoothness” of the depth map. In one aspect, the smoothness of the depth map may be measured by the gradients (or average gradient) between adjacent pixels across the frame at time t 402. For example, an image of a simple scene having few objects may have smooth depth map, whereas an image of a complex scene with many objects may have a less smooth depth map, as the gradient between depths of adjacent pixels changes frequently and significantly to reflect the many objects.

Depth gradient loss function 408 provides a depth gradient loss component to final loss function 405. Though not depicted in FIG. 4, the depth gradient loss component may be associated with a hyperparameter (e.g., a weight) in final loss function 405, which may alter the influence of the depth gradient loss on final loss function 405.

Depth map 260 may also be provided to view synthesis function 418. View synthesis function 418 further takes as inputs one or more context frames 416 and a pose estimate from pose projection function 420 and generates a reconstructed subject frame 422. For example, view synthesis function 418 may perform an interpolation, such as bilinear interpolation, based on a pose projection from pose projection function 420 and using the depth map 260. Pose projection function 420 is generally configured to perform pose estimation, which may include determining a projection from one frame to another.

Context frames 416 may generally be frames near to frame at time t 402. For example, context frames 416 may be some number of frames or time steps on either side of frame at time t 402, such as t+/−1 (adjacent frames), t+/−2 (non-adjacent frames), or the like. Though these examples are symmetric about frame at time t 402, context frames 416 could be non-symmetrically located, such as t−1 and t+3.

Reconstructed frame 422 may be compared against frame at time t 402 by photometric loss function 424 to generate a photometric loss, which is another component of final loss function 405. As discussed above, though not depicted in the figure, the photometric loss component may be associated with a hyperparameter (e.g., a weight) in final loss function 405, which changes the influence of the photometric loss on final loss function 405.

Depth map 260 is provided to depth supervision loss function 412, which takes as a further input estimated depth ground truth values for the frame, generated by depth ground truth for frame function 410, to generate a depth supervision loss. In general, the output of depth ground truth for frame function 410 is a sparse point cloud depth map used as a ground truth.

In some aspects, depth supervision loss function 412 only has or uses estimated depth ground truth values for a portion of the scene in frame at time t 402, thus this step may be referred to as a “partial supervision”. In other words, while depth model 252 provides a depth output for each pixel in frame at time t 402, depth ground truth for frame function 410 may only provide estimated ground truth values for a subset of the pixels in frame at time t 402.

Depth ground truth for frame function 410 may generate estimated depth ground truth values by various different techniques. In one aspect, a sensor fusion function (or module) uses one or more sensors to directly sense depth information from a portion of a subject frame. For example, the depth ground truth values may be point cloud data captured by a LIDAR sensor and aligned to frame at time t 402. Additional information regarding the various aspects of the training architecture of FIG. 4 may be found in U.S. Patent Publication 2023/0023126 A1, published on Jan. 26, 2023, the entire content of which is hereby incorporated by reference.

In an aspect of the present disclosure, depth supervision loss function 412 may take as a further input ground truth depth values of sample pixels 256 of frame at time t 402, generated by structured light analyzer 250, to generate a depth supervision loss. In an aspect, ground truth depth values for sample pixels 256 is a sparse point cloud depth map used as a ground truth of one or more objects of a scene represented in frame at time t 402.

Thus, when training depth model 252, training architecture 400 may use depth ground truth for frame 410 and/or ground truth depth values of sample pixels 256 (e.g., generated by structured light).

The depth supervision loss generated by depth supervision loss function 412 may be masked (using mask operation 415) based on an explainability mask provided by explainability mask function 404. The purpose of the explainability mask is to limit the impact of the depth supervision loss to those pixels in frame at time t 402 that do not have explainable (e.g., estimable) depth.

For example, a pixel in frame at time t 402 may be marked as “non-explainable” if a reprojection error for that pixel in a warped image (e.g., reconstructed frame 422) is higher than the value of the loss for the same pixel with respect to the original unwarped context frame 416. In this example, “warping” refers to the view synthesis operation performed by view synthesis function 418. In other words, if no associated pixel can be found with respect to original frame at time t 402 for the given pixel in reconstructed frame 422, then the given pixel was probably globally non-static (or relatively static to the camera) in frame at time t 402 and therefore cannot be reasonably explained.

The depth supervision loss generated by depth supervision loss function 412 and as modified/masked by the explainability mask produced by explainability mask function 404 is provided as another component to final loss function 405. As above, though not depicted in the figure, depth supervision loss function 412 may be associated with a hyperparameter (e.g., a weight) in final loss function 405, which changes the influence of the depth supervision loss on final loss function 405.

In an aspect, the final or total (multi-component) loss generated by final loss function 405 (which may be generated based a depth gradient loss generated by a depth gradient loss function 408, a (masked) depth supervision loss generated by depth supervision loss function 412, and/or a photometric loss generated by photometric loss function 424) is used to update or refine depth model 252. For example, using gradient descent and/or back propagation, one or more parameters of depth model 252 may be refined or updated based on the total loss generated for a given frame at time t 402.

In aspects, this updating may be performed independently and/or sequentially for a set of frames 402 (e.g., using stochastic gradient descent to sequentially update the parameters of depth model 252 based on each frame) and/or in based on batches of frames 402 (e.g., using batch gradient descent).

Depth model 252 thereby learns to generate improved and more accurate depth estimations in depth map 260. During runtime inferencing, depth model 252 may be used to generate depth map 260 for a sequence of frames 402 based at least in part on a plurality of iterations. Depth map 260 may then be used for a variety of purposes by ADAS 203, such as autonomous driving and/or driving assist (including object detection), as discussed above. In some aspects, at runtime, depth model 252 may be used without consideration or use of other aspects of training architecture 400, such as context frame(s) 416, view synthesis function 418, pose projection function 420, reconstructed frame 422, photometric loss function 424, depth gradient loss function 408, depth ground truth for frame 410, depth supervision loss function 412, explainability mask function 404, and/or final loss function 405.

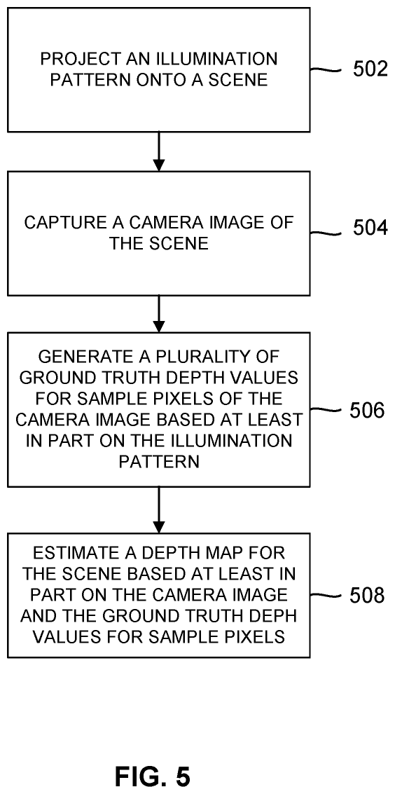

FIG. 5 is a flow diagram illustrating an example method for depth estimation using active sensing and structured light in accordance with the techniques of this disclosure. Although described with respect to computing system 200 (FIG. 2), it should be understood that other computing devices may be configured to perform a method similar to that of FIG. 5.

At block 502, light projector 133 projects an illumination pattern 302 onto a scene 308.

At block 504, camera 132 captures a camera image 254 of the scene 308.

At block 506, structured light analyzer 250 generates a plurality of ground truth depth values for sample pixels 256 of the camera image 254 based at least in part on the illumination pattern 302.

At block 508, depth model 252 estimates depth map 260 for the scene 308 based at least in part on the camera image 254 and the ground truth depth values for sample pixels 256.

ADAS 203 may then use depth map 260 for object detection or other processing. The actions of blocks 502-508 may be repeated for continuous object detection or other processing by ADAS 203 on autonomous vehicle 102 (or other system such as a drone, robot, boat, airplane, etc.).

The following numbered clauses illustrate one or more aspects of the devices and techniques described in this disclosure.
Clause 1. A method including projecting, by a light projector, an illumination pattern onto a scene; capturing, by a camera, a camera image of the scene; generating, by a computing device, a plurality of ground truth depth values for sample pixels of the camera image based at least in part on the illumination pattern; and estimating a depth map for the scene based at least in part on the camera image and the ground truth depth values for sample pixels.
Clause 2. The method of clause 1, wherein estimating the depth map includes estimating the depth map using a machine learning depth model.
Clause 3. The method of clause 2, further including training the machine learning depth model using the ground truth depth values for sample pixels.
Clause 4. The method of clause 2, further including training the machine learning depth model using the ground truth depth values for sample pixels and estimated depth ground truth values for the camera image generated from Light Detection and Ranging (LIDAR) sensor data.
Clause 5. The method of clause 1, wherein the light projector, the camera, and the computing device are disposed on a vehicle.
Clause 6. The method of clause 5, further including projecting, by the light projector, the illumination pattern onto the scene in front of the vehicle.
Clause 7. The method of clause 1, wherein the light projector projects the illumination pattern using near infrared light.
Clause 8. The method of clause 1, further including detecting at least one object in the scene based at least in part on the depth map.
Clause 9. The method of clause 8, further including resolving a scale of the at least one object in the scene based at least in part on the depth map.
Clause 10. The method of clause 1, wherein estimating the depth map for the scene includes monocular depth estimation.
Clause 11. An apparatus including a memory that stores instructions; and processing circuitry that executes the instructions to generate a plurality of ground truth depth values for sample pixels of a scene captured in a camera image by a camera, one or more objects of the scene reflecting light projected onto the scene by a light projector in an illumination pattern; and estimate a depth map for the scene based at least in part on the camera image and the ground truth depth values for sample pixels.
Clause 12. The apparatus of clause 11, wherein the processing circuitry execute instructions to estimate the depth map includes the processing circuitry to execute instructions to estimate the depth map using a machine learning depth model.
Clause 13. The apparatus of clause 12, further including the processing circuitry to execute instructions to train the machine learning depth model using the ground truth depth values for sample pixels.
Clause 14. The apparatus of claim 12, further including the processing circuitry to execute instructions to train the machine learning depth model using the ground truth depth values for sample pixels and estimated depth ground truth values for the camera image generated from LIDAR sensor data.
Clause 15. The apparatus of clause 11, wherein the light projector, the camera, the memory and the processing circuitry are disposed on a vehicle.
Clause 16. The apparatus of clause 15, wherein the light projector is to project an illumination pattern onto the scene in front of the vehicle.
Clause 17. Non-transitory computer-readable storage media including instructions, that when executed by processing circuitry of a computing system, cause the processing circuitry to generate a plurality of ground truth depth values for sample pixels of a scene captured in a camera image by a camera, one or more objects of the scene reflecting light projected onto the scene by a light projector in an illumination pattern; and estimate a depth map for the scene based at least in part on the camera image and the ground truth depth values for sample pixels.
Clause 18. The non-transitory computer-readable storage media of clause 17, including instructions, that when executed by processing circuitry, cause the processing circuitry to detect the one or more objects in the scene based at least in part on the depth map.
Clause 19. The non-transitory computer-readable storage media of claim 18, including instructions, that when executed by processing circuitry, cause the processing circuitry to resolve a scale of the one or more objects in the scene based at least in part on the depth map.
Clause 20. The non-transitory computer-readable storage media of claim 17, including instructions, that when executed by processing circuitry, cause the processing circuitry to estimate the depth map for the scene by monocular depth estimation.
Clause 21. A computing system including means for performing any of the methods of Clauses 1 through 10.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of random-access memory (RAM), read-only memory (ROM), electrically erasable ROM (EEPROM), compact disc ROM (CD-ROM) or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
projecting, by a light projector, an illumination pattern onto a scene;
capturing, by a camera, a camera image of the scene;
generating, by a computing device, a plurality of ground truth depth values for sample pixels of the camera image based at least in part on the illumination pattern; and
estimating a depth map for the scene based at least in part on the camera image and the ground truth depth values for sample pixels.

2. The method of claim 1, wherein estimating the depth map comprises estimating the depth map using a machine learning depth model.

3. The method of claim 2, further comprising training the machine learning depth model using the ground truth depth values for sample pixels.

4. The method of claim 2, further comprising training the machine learning depth model using the ground truth depth values for sample pixels and estimated depth ground truth values for the camera image generated from Light Detection and Ranging (LIDAR) sensor data.

5. The method of claim 1, wherein the light projector, the camera, and the computing device are disposed on a vehicle.

6. The method of claim 5, further comprising projecting, by the light projector, the illumination pattern onto the scene in front of the vehicle.

7. The method of claim 1, wherein the light projector projects the illumination pattern using near infrared light.

8. The method of claim 1, further comprising detecting at least one object in the scene based at least in part on the depth map.

9. The method of claim 8, further comprising resolving a scale of the at least one object in the scene based at least in part on the depth map.

10. The method of claim 1, wherein estimating the depth map for the scene comprises monocular depth estimation.

11. An apparatus comprising:
a memory that stores instructions; and
processing circuitry that executes the instructions to:
generate a plurality of ground truth depth values for sample pixels of a scene captured in a camera image by a camera, one or more objects of the scene reflecting light projected onto the scene by a light projector in an illumination pattern; and
estimate a depth map for the scene based at least in part on the camera image and the ground truth depth values for sample pixels.

12. The apparatus of claim 11, wherein the processing circuitry execute instructions to estimate the depth map comprises the processing circuitry to execute instructions to estimate the depth map using a machine learning depth model.

13. The apparatus of claim 12, further comprising the processing circuitry to execute instructions to train the machine learning depth model using the ground truth depth values for sample pixels.

14. The apparatus of claim 12, further comprising the processing circuitry to execute instructions to train the machine learning depth model using the ground truth depth values for sample pixels and estimated depth ground truth values for the camera image generated from LIDAR sensor data.

15. The apparatus of claim 11, wherein the light projector, the camera, the memory and the processing circuitry are disposed on a vehicle.

16. The apparatus of claim 15, wherein the light projector is to project an illumination pattern onto the scene in front of the vehicle.

17. Non-transitory computer-readable storage media comprising instructions, that when executed by processing circuitry of a computing system, cause the processing circuitry to:
generate a plurality of ground truth depth values for sample pixels of a scene captured in a camera image by a camera, one or more objects of the scene reflecting light projected onto the scene by a light projector in an illumination pattern; and
estimate a depth map for the scene based at least in part on the camera image and the ground truth depth values for sample pixels.

18. The non-transitory computer-readable storage media of claim 17, comprising instructions, that when executed by processing circuitry, cause the processing circuitry to:
detect the one or more objects in the scene based at least in part on the depth map.

19. The non-transitory computer-readable storage media of claim 18, comprising instructions, that when executed by processing circuitry, cause the processing circuitry to:
resolve a scale of the one or more objects in the scene based at least in part on the depth map.

20. The non-transitory computer-readable storage media of claim 17, comprising instructions, that when executed by processing circuitry, cause the processing circuitry to:
estimate the depth map for the scene by monocular depth estimation.
